(19) United States
(12) Patent Application Publication
(10) Pub. No.: US 2026/0227977 A1
(43) Pub. Date: Aug. 6, 2026

(54) ENHANCING DEVELOPER TOOL CHAIN AND RUNTIME FOR SUSTAINABLE SOFTWARE DEVELOPMENT

(71) Applicant: Hewlett Packard Enterprise Development LP, Spring, TX (US)

(72) Inventors: Soumitra Chatterjee, Bangalore (IN); Srinivasan Varadarajan Sahasranamam, Bangalore (IN); Umesh Markandaya Lakshminarasimha, Bangalore (IN); Jagadeesha Nagol Hanamanthappa, Bangalore (IN)

(21) Appl. No.: 19/079,889

(22) Filed: Mar. 14, 2025

(30) Foreign Application Priority Data
Jan. 31, 2025 (IN) 202511008412

(51) Int. Cl. G06F 8/41

(52) U.S. Cl. CPC G06F 8/4432; G06F 8/456

(57) ABSTRACT

A system identifies, in a program, a region of code annotated with a power profile. The system translates the program based on a compiler or an interpreter. The system inserts, in the translated program based on the annotated region of code, a call to a power-control function corresponding to the power profile. The power profile comprises a power-saving operation to be performed at or before runtime execution of the translated annotated region of code. The system performs the power-saving operation at or before runtime execution of the translated program based on the inserted call to the power-control function.

### BACKGROUND

### Field

Sustainability with respect to energy usage and power consumption has become increasingly important in many industries. In the computing industry, approaches to achieve sustainability goals may leverage energy-efficient infrastructures and products. For example, many energy-efficient solutions depend on in-silicon features to provide power savings in hardware elements (e.g., processor C-States and refresh rates of dynamic random-access memory (DRAM)). However, the workload running on these infrastructures and products may also drive the overall power consumption.

### BRIEF DESCRIPTION OF THE FIGURES

FIG. 1A illustrates a diagram of an architecture which facilitates enhancing developer tool chain and runtime for sustainable software development, in accordance with an aspect of the present application.

FIG. 1B illustrates a detailed view of the runtime environment of FIG. 1A, in accordance with an aspect of the present application.

FIG. 2A depicts a diagram of the impact on power consumption of inserting a delay or stall cycle in a region of code, in accordance with an aspect of the present application.

FIG. 2B depicts a diagram of the impact on power savings of reducing a compute resource span for a region of code, in accordance with an aspect of the present application.

FIG. 3 presents a flowchart illustrating a method which facilitates enhancing developer tool chain and runtime for sustainable software development, in accordance with an aspect of the present application.

FIG. 4 illustrates a computer system which facilitates enhancing developer tool chain and runtime for sustainable software development, in accordance with an aspect of the present application.

FIG. 5 illustrates a computer-readable medium which facilitates enhancing developer tool chain and runtime for sustainable software development, in accordance with an aspect of the present application.

In the figures, like reference numerals refer to the same figure elements.

### DETAILED DESCRIPTION

The following description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

The described aspects provide a mechanism for a programmer or developer of software code to identify certain regions of code (e.g., a tight loop) which may benefit from power-saving operations for execution (e.g., at or before runtime), which can result in more sustainable software development.

As described above, sustainability with respect to energy usage and power consumption has become increasingly important in many industries. In the computing industry, approaches to achieve sustainability goals may leverage energy-efficient infrastructures and products. For example, many energy-efficient solutions depend on in-silicon features to provide power savings in hardware elements (e.g., processor C-States, DRAM refresh rates, etc.). However, the workload running on these infrastructures and products may also drive the overall power consumption.

While some existing programming constructs may allow a developer to specify how an entire program is to be handled by a compiler, these constructs do not address the sustainability issues related to the developer tool chain. Furthermore, current constructs may require specific knowledge of the architecture and platform to be used in compiling and executing the program. These restrictions may be limiting when attempting to achieve the goal of sustainable software development.

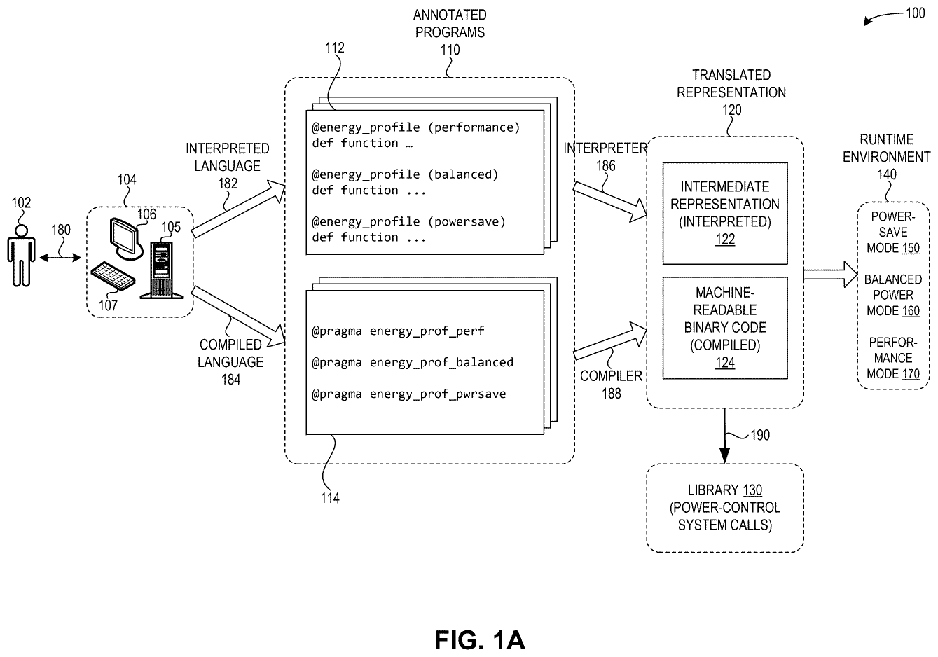

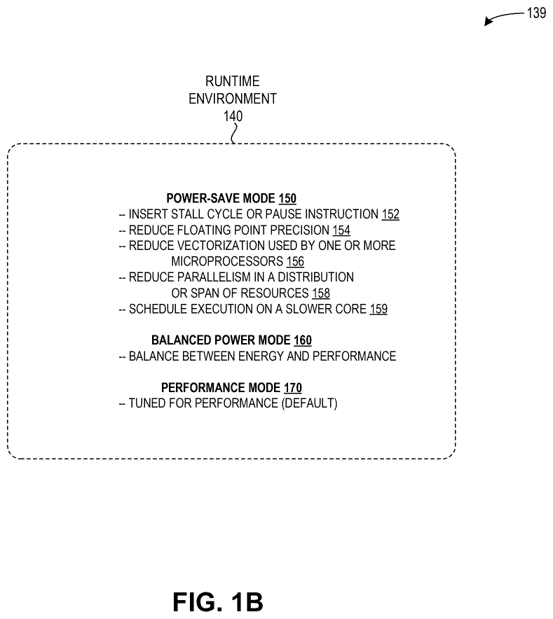

The described aspects address these limitations by allowing a developer to identify and annotate a specific region of code in a program with a power profile. The annotated code may be subsequently used in compiling and running the program based on power-saving operations associated with the power profile, without requiring any knowledge of the specific architecture or platform. Furthermore, the developer may use their specific knowledge of the program while writing the program to identify regions of code which may be best suited for power-savings operations. In the described aspects, the developer can mark, using the annotations, a power profile or mode to be applied to the specific region of code at or before runtime. The power profile or mode may include one of at least three different profiles, e.g.: a power-save mode in which one or more power-saving operations are performed at or before runtime execution; a performance mode comprising a default mode in which performance-optimizing operations are performed at or before runtime execution; or a balanced power mode in which a mix of power-saving operations and performance-optimizing operations are performed at or before runtime execution. Power-saving operations are described below in relation to FIGS. 1A and 1B.

After the developer has marked or annotated the specific region of code in the program, a compiler or interpreter may translate the program and insert, based on the annotated region, a call to a corresponding power-control function. The system can then perform the power-saving operation at or before runtime based on the inserted call.

FIG. 1A illustrates a diagram 100 of an architecture which facilitates enhancing developer tool chain and runtime for sustainable software development, in accordance with an aspect of the present application. Diagram 100 can represent a software developer tool chain and runtime support. A developer (also referred to as a “user”) 102 may be associated with a system 104 (including a computing device 105 and peripheral input/output devices 106 and 107). Developer 102 can develop a software program using system 104 and based on an interpreted language or a compiled language.

In a compiled language, the source code may be written in a high-level language and translated by a compiler directly to machine-readable binary code before execution. Examples of a compiled language may include, but are not limited to, C, C++, Java, Fortran, Rust, Pascal, etc. In an interpreted language, the source code may be translated by an interpreter into an intermediate representation and executed line-by-line (or statement-by-statement of the intermediate representation). Examples of an interpreted language may include, but are not limited to, Python, JavaScript, Ruby, Perl, etc.

Developer 102 may identify certain regions of code in the software program which may be appropriate for executing under a power-savings profile. For example, developer 102 may identify a tight loop whose execution does not impact the overall application/workload performance and can thus be executed in a power-save mode. Developer 102 can annotate the region of code, e.g., by placing source-language-specific tags at the start and end of the region of code. For a compiled language, developer 102 can use, e.g., “pragmas” or “attributes” to mark the code. A pragma may be a compiler directive which allows the developer to provide additional information to the compiler, and an attribute can be used by the developer to attach extra information to language entities with a generalized syntax rather than adding new syntactic constructs or keywords for each feature. For an interpreted language, developer 102 can use, e.g., a “decorator” function which takes as input an original function (as parameters) and extends or modifies its behavior without changing the code of the original function, thus “wrapping” the original function with additional functionality.

For example, in diagram 100, developer 102 may annotate a region of code in a program (via a communication or user input 180 to system 104), which is indicated as annotated programs 110. The annotation may indicate a power profile to be applied to the region of code at or before runtime execution of the code. In an interpreted language, developer 102 may mark up the region using decorators (e.g., as indicated in annotated program 112), while in a compiled language, developer 102 may mark up the region using pragmas (e.g., as indicated in annotated program 114). The power profile indicated by the developer 102 using the source-language appropriate construct (e.g. pragmas, annotations, decorators, etc.) will be used by the compiler or interpreter (as the case may be) to insert appropriate application programming interface (API) calls into the generated code (machine code in case of compiled languages and intermediate representation in case of interpreted languages). The compiler/interpreter may insert specific API calls for each power profile, or may insert the same API call with the power profile as an input parameter to the call. The API call may optionally include additional parameters. In FIG. 1, developer 102 is depicted and described as a user for illustrative purposes only. The operations performed by developer 102 may be performed by an automated system, e.g., based on a machine learning model. The automated system may perform the operations described herein, including but limited to: developing a software program; identifying and annotating regions of code, e.g., based on code performance reports; applying strategies or policies based on respective power profiles; and leveraging artificial intelligence (AI) to identify candidate regions of code to be annotated.

Examples of individual API calls specific to each power profile can be as follows:
_enter_region_power_save( )
. . . application code . . .
_exit_region_power_save( )

Similarly, examples of API calls with the power profile indicated as an input parameter can be as follows:
_enter_region_power_profile(power_save)
. . . application code . . .
_exit_region_power_profile(power_save)

These are non-limiting examples, and the actual API calls can be variations of the above, optionally with additional parameters. When executed (as described further below), the API call may switch a current power profile from a previous power profile to the new power profile and subsequently return the previous power profile (i.e., return to the previous power profile when execution of the annotated region of code corresponding to the new power profile has been completed).

The code, including the annotated region or regions, may be sent to and processed by an interpreter or a compiler, resulting in a translated representation 120. For example: an interpreter may translate the annotated code (as indicated by 186), resulting in intermediate representation 122; and a compiler may translate the annotated code (as indicated by 188), resulting in machine-readable binary code 124. The compiler/interpreter may choose to process the annotated code differently based on the annotated power profile. For example, depending on the power profile indicated for a specific annotated region of code, a compiler may heuristically decide to turn on/off vectorization for the annotated region independent of how the rest of the application is being compiled. This may be an independent functionality apart from the runtime aspects of power control described above.

The system may make calls to a power-control function corresponding to the power profile indicated by the annotated region of code. The power-control function may correspond to a new or existing library call. For example, the system may make instrumented calls (via a communication 190) to a library 130, which may contain power-control system calls. A library may include one or more versions of power-control system calls which correspond to the indicated power profile, e.g., an aggressive power-save mode version, a moderate power-save mode version, or a conservative power-save mode version.

As a result, during runtime of the annotated region of code (indicated by runtime environment 140), the system may enter into a particular power-related mode which may include, e.g., a power-save mode 150, a balanced power mode 160, or a performance mode 170. FIG. 1B illustrates a detailed view 139 of runtime environment 140 of FIG. 1A, in accordance with an aspect of the present application. As depicted in detailed view 139, the power-related modes 150, 160, and 170 may be indicated by the power profile. Power-save mode 150 may include several power-saving operations which can be performed at or before runtime. Examples of power-saving operations which can be performed before runtime may include: inserting a stall cycle or a pause instruction (152); reducing floating point precision (154); reducing vectorization used by one or more microprocessors (156); and reducing parallelism in a distribution or span of resources (158). Examples of power-saving operations which can be performed at runtime may include: determining that an architecture associated with the runtime execution supports cores associated with a variation in clock speeds (also known as “frequency heterogeneity”); and scheduling the runtime execution on a slower core, i.e., on a first core instead of a second core, where a clock speed associated with the first core is slower than a clock speed associated with the second core (159).

Balanced power mode 160 may include a mode in which a mix of power-saving operations and performance-optimizing operations can be performed at or before runtime execution of the translated annotated region of code, e.g., a balance between energy and performance. The configuration or weight given to power-saving operations as compared to performance-optimizing operations may be a parameter set by the user or a default balance set (heuristically, or by other means such as artificial intelligence (AI) driven models, etc.) by the system.

Performance mode 170 may be configured as a default mode and may include performing operations which are tuned for performance.

Thus, the described aspects can result in sustainable software development (as reflected in a reduction in power consumption) by enabling a developer (or automated system) to design and develop software programs with energy efficiency hooks (i.e., annotated regions of code), which in turn may allow the software to regulate its resource usage and further to control and reduce the overall power consumption.

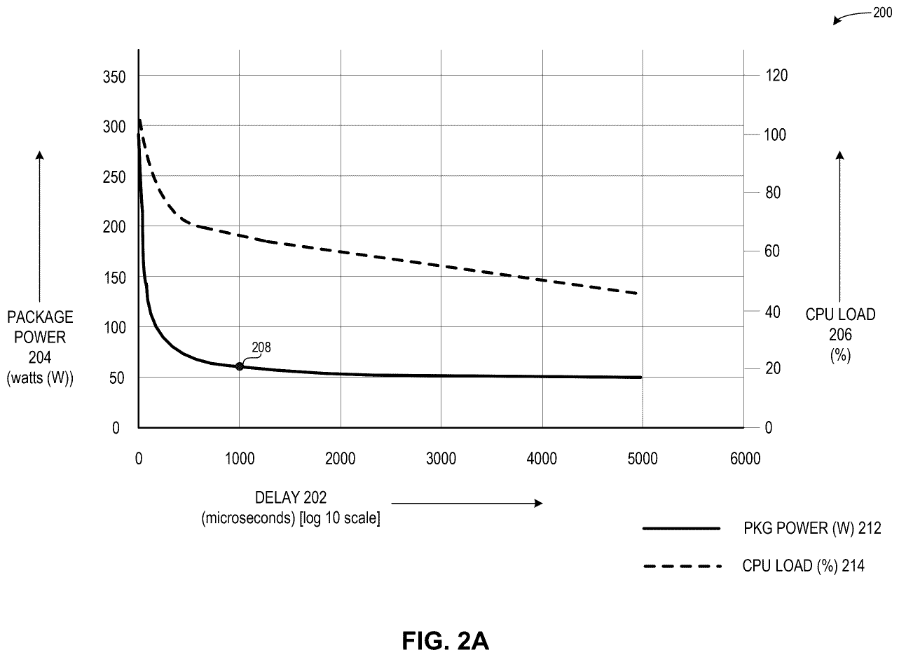

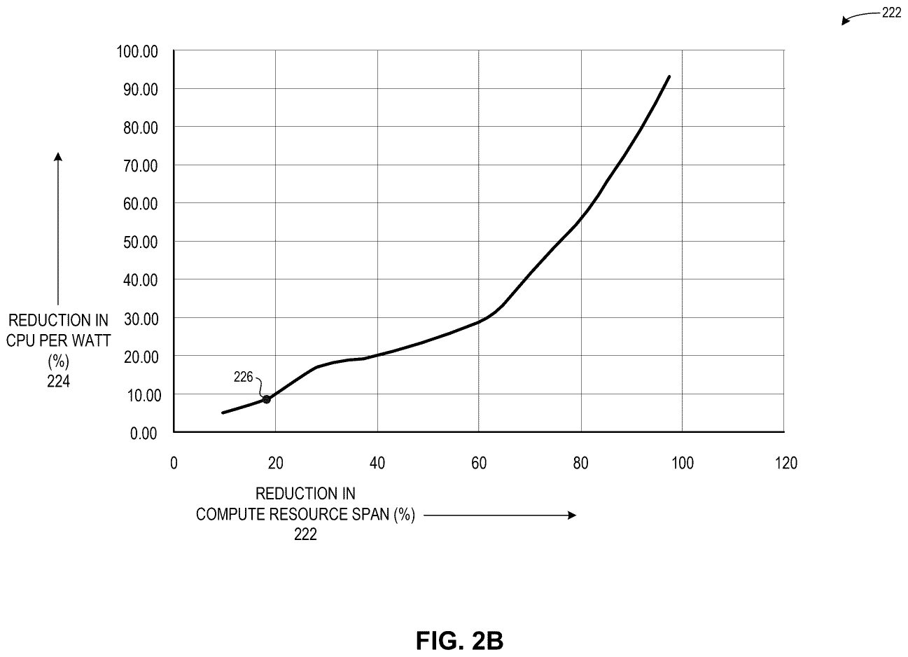

FIG. 2A depicts a diagram 200 of the impact on power consumption of inserting a delay or stall cycle in a region of code, in accordance with an aspect of the present application. Diagram 200 illustrates the results of simulating the process of slowing down code associated with a compute-bound workload, e.g., by using a compute-bound application that calls sqrt( ) in a tight loop (on all available cores) and by injecting delays using nanosleep( ) from 0.5 microseconds to 5 milliseconds. In diagram 200, an x-axis 202 indicates the application delay in microseconds, a left y-axis 204 indicates the energy consumption (package power in watts (W)), and a right y-axis 206 indicates the load on the central processing unit (CPU) as a percentage of CPU occupancy. The result of the energy consumption based on the application delay is indicated by a solid line (as depicted by index element 212), while the result of the CPU load based on the application delay is indicated by a dashed line (as depicted by index element 214). The results indicate that varying the sleep duration (i.e., the delay) over a range of values can result in a significant drop in both the power consumption and the CPU load. For example, a delay (i.e., a stall or pause) of 1000 microseconds may result in drop of the energy consumption from 300 W to approximately 65 W (as indicated by an element 208).

FIG. 2B depicts a diagram 220 of the impact on power savings of reducing a compute resource span for a region of code, in accordance with an aspect of the present application. In diagram 220, an x-axis 222 indicates the reduction in the span of compute resources (i.e., using fewer resources), and a y-axis 224 indicates the reduction in power consumption measured by CPU performance per watt. For example, reducing the compute resource span by approximately 18% can result in a reduction in CPU performance per watt of approximately 9.5% (as indicated by an element 226). Thus, the results indicate that reducing the compute resource span can result in a significant drop in power consumption (indicated by the CPU performance per watt).

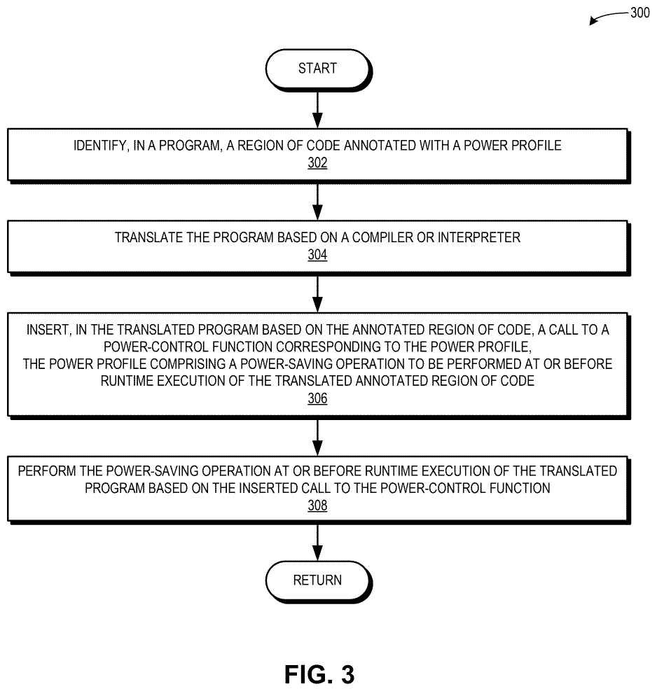

FIG. 3 presents a flowchart 300 illustrating a method which facilitates enhancing developer tool chain and runtime for sustainable software development, in accordance with an aspect of the present application. During operation, the system identifies, in a program, a region of code annotated with a power profile (operation 302). For example, in FIG. 1A, developer 102 (or an automated system) may annotate, via communication or input 180 on system 104, a region of code, which may result in an annotated program (e.g., annotated program 112 if using an interpreted language and annotated program 114 is using a compiled language).

The system translates the program based on a compiler or an interpreter (operation 304). As depicted in FIG. 1A, an interpreter may translate the annotated program 112 (as depicted by 186) or a compiler may translate the annotated program 114 (as depicted by 188). The result of the translation may be translated representation 120, e.g.: intermediate representation 122 (for an interpreted language as the result of an interpreter); or machine-readable binary code (for a compiled language as the result of a compiler).

The system inserts, in the translated program based on the annotated region of code, a call to a power-control function corresponding to the power profile, the power profile comprising a power-saving operation to be performed at or before runtime execution of the translated annotated region of code (operation 306). For example, in FIG. 1A, the system may insert, in translated representation 120, power-control system calls in library 130, as described above in relation to communication 190.

The system performs the power-saving operation at or before runtime execution of the translated program based on the inserted call to the power-control function (operation 308). Runtime environment 140 in FIGS. 1A and 1B depict three power modes corresponding to the power profile indicated in the respective annotated region of code: power-save mode 150; balanced power mode 160; and performance mode 170. Each mode may include specific power-saving operations. Specifically, as depicted in FIG. 1B, power-save mode 150 may include several power-saving operations which can be performed at or before runtime, including but not limited to, e.g.: inserting a stall cycle or a pause instruction (152); reducing floating point precision (154); reducing vectorization used by one or more microprocessors (156); and reducing parallelism in a distribution or span of resources (158); determining that an architecture associated with the runtime execution supports cores associated with a variation in clock speeds; and scheduling the runtime execution on a slower core, i.e., on a first core instead of a second core, where a clock speed associated with the first core is slower than a clock speed associated with the second core (159). Some of these operations (e.g., 152-158) may be performed before runtime, while other operations (e.g., 159) may be performed at runtime. Balanced power mode 160 and performance mode 170 may include operations as described above in relation to FIGS. 1A and 1B.

In some aspects, the system may automatically insert the relevant API calls (e.g., decorators for interpreted languages and pragmas for compiled languages) based on an analysis of historical data over time. In addition, the system may use various strategies or policies for respective power profiles and may also modify the power profile dynamically during runtime of an application. The system may also generate libraries or entry points to functions which can provide multiple implementations of the same functionality for different power profiles. Furthermore, the system may leverage artificial intelligence (AI) to automatically detect regions of code which are to be marked for application of power-saving operations based on patterns or idioms, e.g., if a section of code is established as input/output intensive at the time of compilation. The system may also use AI to determine optimal sweet-spot ranges which maximize the balance between energy-efficiency and performance.

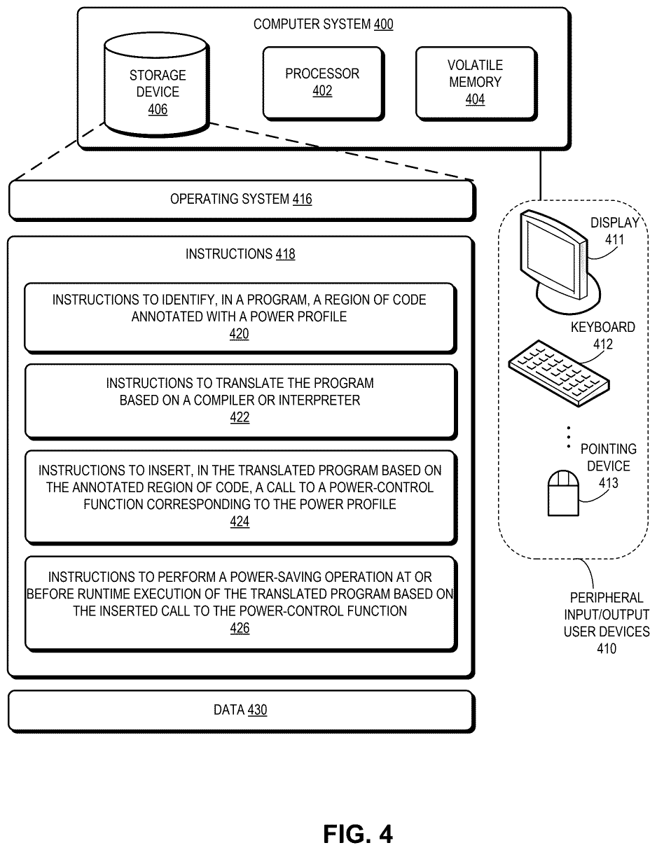

FIG. 4 illustrates a computer system 400 which facilitates enhancing developer tool chain and runtime for sustainable software development, in accordance with an aspect of the present application. Computer system 400 includes a processor 402, a memory 404, and a storage device 406. Memory 404 may include a volatile memory (e.g., random access memory (RAM)) that serves as a managed memory and can be used to store one or more memory pools. Furthermore, computer system 400 may be coupled to peripheral I/O user devices 410 (e.g., a display device 411, a keyboard 412, and a pointing device 413). Storage device 406 includes non-transitory computer-readable storage medium and stores an operating system 416, instructions 418, and data 430. Computer system 400 may be a network device 400 with at least one processing resource (e.g., 402) and circuitry (including modules, units, components, etc. in hardware, software, or a combination of hardware and software, e.g., 406) to perform the methods, operations, computations, determinations, and functions described herein. In computer system 400, the circuitry or storage device may store instructions which when executed by the at least one processing resource (e.g., 402) comprises instructions to perform the operations described herein. Computer system 400 may include fewer or more entities or instructions than those shown in FIG. 4.

Instructions 418 can include instructions, which when executed by computer system 400, can cause computer system 400 to perform methods and/or processes described in this disclosure. Specifically, instructions 418 may include instructions 420 to identify, in a program, a region of code annotated with a power profile, as described above in relation to developer 102, communication 180, and system 104 of FIG. 1A and further in relation to operation 302 of FIG. 3.

Instructions 418 may also include instructions 422 to translate the program based on a compiler or an interpreter. For example, an interpreter may translate annotated program 112 (as depicted by 186) or a compiler may translate annotated program 114 (as depicted by 188), as described above in relation to FIG. 1A. The result of the translation may be translated representation 120, e.g., intermediate representation 122 (for an interpreted language as the result of an interpreter) or machine-readable binary code (for a compiled language as the result of a compiler), as described above in relation to FIG. 1A and operation 304 of FIG. 3.

Instructions 418 may include instructions 424 to insert, in the translated program based on the annotated region of code, a call to a power-control function corresponding to the power profile, as described above in relation to communication 190 and library 130 of FIG. 1A and operation 306 of FIG. 3.

Instructions 418 may include instructions 426 to perform a power-saving operation at or before runtime execution of the translated program based on the inserted call to the power-control function, as described above in relation to runtime environment 140 of FIGS. 1A and 1B and operation 308 of FIG. 3.

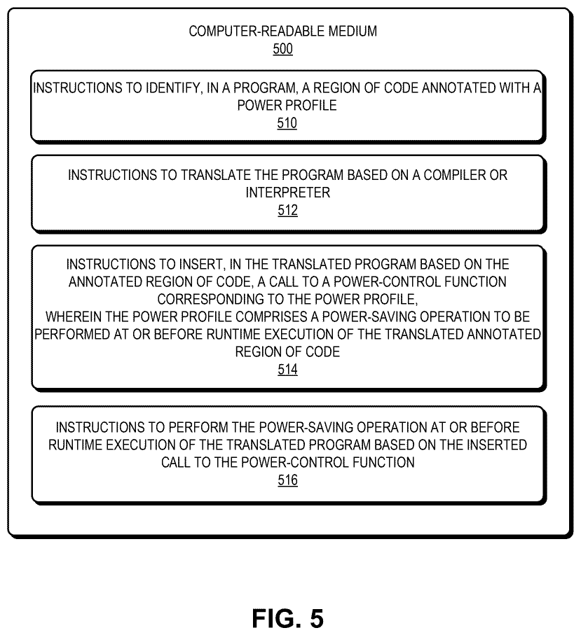

Instructions 418 may include more instructions than those shown in FIG. 4. For example, instructions 418 may include instructions for executing the operations described above in relation to: the programs, code, annotations, translations, results, and communications in FIGS. 1A and 1B; the operations of flowchart 300 in FIG. 3; and the instructions of CRM 500 of FIG. 5.

Data 430 can include any data that is required as input or that is generated as output by the methods, operations, communications, and/or processes described in this disclosure. Specifically, data 430 can store at least: a program; code; a region of code; an annotation; an annotated program; a translated representation of code; an indicator of an interpreted language or a compiled language; a result of an interpreter or a compiler; an intermediate representation of code; machine-readable binary code; an indicator of a library; an indicator of one or more system calls; an indicator of a mode associated with a power profile; and an indicator of a power-saving operation.

FIG. 5 illustrates a computer-readable medium (CRM) 500 which facilitates enhancing developer tool chain and runtime for sustainable software development, in accordance with an aspect of the present application. CRM 500 can be a non-transitory computer-readable medium or device storing instructions that when executed by a computer or processor cause the computer or processor to perform a method, including the methods and operations described herein.

CRM 500 may store instructions 510 to identify, in a program, a region of code annotated with a power profile, as described above in relation to developer 102, communication 180, and system 104 of FIG. 1A and further in relation to operation 302 of FIG. 3.

CRM 500 may store instructions 512 to translate the program based on a compiler or an interpreter, as described above in relation to FIG. 1A and operation 304 of FIG. 3.

CRM 500 may store instructions 514 to insert, in the translated program based on the annotated region of code, a call to a power-control function corresponding to the power profile, wherein the power profile comprises a power-saving operation to be performed at or before runtime execution of the translated annotated region of code, as described above in relation to communication 190 and library 130 of FIG. 1A, runtime environment 140 of FIGS. 1A and 1B, and operation 306 of FIG. 3.

CRM 500 may store instructions 516 to perform the power-saving operation at or before runtime execution of the translated program based on the inserted call to the power-control function, as described above in relation to runtime environment 140 of FIGS. 1A and 1B and operation 308 of FIG. 3. Examples of improvements in energy efficiency based on the above-described actions are provided in relation to the results in FIGS. 2A and 2B.

CRM 500 may include more instructions than those shown in FIG. 5. For example, CRM 500 may also store instructions to execute the operations described above in relation to: the programs, code, annotations, translations, results, and communications in FIGS. 1A and 1B; the operations of flowchart 300 in FIG. 3; and instructions 418 of computer system 400 of FIG. 4.

In general, the disclosed aspects provide a method, computer system, and non-transitory computer-readable storage medium which facilitate enhancing developer tool chain and runtime for sustainable software development. In one aspect, the system identifies, in a program, a region of code annotated with a power profile. The system translates the program based on a compiler or an interpreter. The system inserts, in the translated program based on the annotated region of code, a call to a power-control function corresponding to the power profile, the power profile comprising a power-saving operation to be performed at or before runtime execution of the translated annotated region of code. The system performs the power-saving operation at or before runtime execution of the translated program based on the inserted call to the power-control function.

In a variation on this aspect, the program in which the region of code is annotated is based on a compiled language or an interpreted language.

In a further variation on this aspect, the translated program based on the compiler or the interpreter comprises, respectively, compiled binary code or an intermediate representation of interpreted code, both of which include the inserted call to the power-control function.

In a further variation, the annotated region of code in the program is indicated by at least one of: a pragma or an attribute in a compiled language which is translated based on the compiler; a decorator in an interpreted language which is translated based on the interpreter; or a mechanism which specifies a special characteristic of the region of code based on the compiler or the interpreter.

In a further variation, the system applies the power profile to the translated annotated region of code. The power profile comprises at least one of: a power-save mode in which one or more power-saving operations are performed at or before runtime execution of the translated annotated region of code; a performance mode comprising a default mode in which performance-optimizing operations are performed at or before runtime execution of the translated annotated region of code; or a balanced power mode in which a mix of power-saving operations and performance-optimizing operations are performed at or before runtime execution of the translated annotated region of code. The system may apply the power profile as part of the code generation by the compiler or the interpreter, i.e., during the process of generating the machine-readable binary code (compiler) or generating the intermediate representation (interpreter).

In a further variation, performing the power-saving operation before execution comprises at least one of: inserting a stall cycle or a pause instruction; reducing floating point precision; reducing vectorization used by one or more microprocessors; or reducing parallelism in a distribution or span of resources.

In a further variation, performing the power-saving operation performed at execution comprises: determining that an architecture associated with the runtime execution supports cores associated with a variation in clock speeds; and scheduling the runtime execution on a first core instead of a second core, wherein the first core is associated with a first clock speed and the second core is associated with a second clock speed, and wherein the first clock speed is slower than the second clock speed.

In a further variation, the region of code in the program is annotated by a developer of the program. The indicated power profile comprises an application programming interface (API) call. The API call takes as input the power profile as a new power profile and associated parameters, switches a current power profile from a previous power profile to the new power profile, and returns the previous power profile

Another aspect provides a computer system comprising at least one processing resource and a storage device (e.g., circuitry) storing instructions which when executed by at least one processing resource comprises instructions to identify, in a program, a region of code annotated with a power profile. The instructions are further to translate the program based on a compiler or an interpreter. The instructions are further to insert, in the translated program based on the annotated region of code, a call to a power-control function corresponding to the power profile. The instructions are further to perform a power-saving operation at or before runtime execution of the translated program based on the inserted call to the power-control function. The computer system may include a content-processing system which includes the above-described instructions and instructions to perform the operations described herein, including in relation to: the programs, code, annotations, translations, results, and communications in FIGS. 1A and 1B; the operations of flowchart 300 in FIG. 3; and the instructions of CRM 500 of FIG. 5.

Yet another aspect provides a non-transitory computer-readable storage medium (CRM) storing instructions that when executed by a computer cause the computer to identify, in a program, a region of code annotated with a power profile. The instructions are further to translate the program based on a compiler or an interpreter. The instructions are further to insert, in the translated program based on the annotated region of code, a call to a power-control function corresponding to the power profile, wherein the power profile comprises a power-saving operation to be performed at or before runtime execution of the translated annotated region of code. The instructions are further to perform the power-saving operation at or before runtime execution of the translated program based on the inserted call to the power-control function. The CRM can also store instructions for executing the operations described above in relation to: the programs, code, annotations, translations, results, and communications in FIGS. 1A and 1B; the operations of flowchart 300 in FIG. 3; and instructions 418 of computer system 400 of FIG. 4.

The foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
identifying, in a program, a region of code annotated with a power profile;
translating the program based on a compiler or an interpreter;
inserting, in the translated program based on the annotated region of code, a call to a power-control function corresponding to the power profile, the power profile comprising a power-saving operation to be performed at or before runtime execution of the translated annotated region of code; and
performing the power-saving operation at or before runtime execution of the translated program based on the inserted call to the power-control function.

2. The method of claim 1,
wherein the program in which the region of code is annotated is based on a compiled language or an interpreted language.

3. The method of claim 1,
wherein the translated program based on the compiler or the interpreter comprises, respectively, compiled binary code or an intermediate representation of interpreted code, both of which include the inserted call to the power-control function.

4. The method of claim 1, wherein the annotated region of code in the program is indicated by at least one of:
a pragma or an attribute in a compiled language which is translated based on the compiler;
a decorator in an interpreted language which is translated based on the interpreter; or
a mechanism which specifies a special characteristic of the region of code based on the compiler or the interpreter.

5. The method of claim 1, further comprising:
applying the power profile to the translated annotated region of code,
wherein the power profile comprises at least one of:
a power-save mode in which one or more power-saving operations are performed at or before runtime execution of the translated annotated region of code;
a performance mode comprising a default mode in which performance-optimizing operations are performed at or before runtime execution of the translated annotated region of code; or
a balanced power mode in which a mix of power-saving operations and performance-optimizing operations are performed at or before runtime execution of the translated annotated region of code; and
applying the power profile as part of code generation by the compiler or the interpreter.

6. The method of claim 1, wherein performing the power-saving operation before execution comprises at least one of:
inserting a stall cycle or a pause instruction;
reducing floating point precision;
reducing vectorization used by one or more microprocessors; or
reducing parallelism in a distribution or span of resources.

7. The method of claim 1, wherein performing the power-saving operation performed at execution comprises:
determining that an architecture associated with the runtime execution supports cores associated with a variation in clock speeds; and
scheduling the runtime execution on a first core instead of a second core,
wherein the first core is associated with a first clock speed and the second core is associated with a second clock speed, and
wherein the first clock speed is slower than the second clock speed.

8. The method of claim 1,
wherein the region of code in the program is annotated by a developer of the program,
wherein the indicated power profile comprises an application programming interface (API) call, and
wherein the API call takes as input the power profile as a new power profile and associated parameters, switches a current power profile from a previous power profile to the new power profile, and returns the previous power profile.

9. A computer system, comprising:
at least one processing resource; and
a storage device storing instructions which when executed by the at least one processing resource comprise instructions to:
identify, in a program, a region of code annotated with a power profile;
translate the program based on a compiler or an interpreter;
insert, in the translated program based on the annotated region of code, a call to a power-control function corresponding to the power profile; and
perform a power-saving operation at or before runtime execution of the translated program based on the inserted call to the power-control function.

10. The computer system of claim 9,
wherein the program in which the region of code is annotated is based on a compiled language or an interpreted language,
wherein the translated program based on the compiler or the interpreter comprises, respectively, compiled binary code or an intermediate representation of interpreted code, both of which include the inserted call to the power-control function.

11. The computer system of claim 9, wherein the annotated region of code in the program is indicated by at least one of:
a pragma or an attribute in a compiled language which is translated based on the compiler;
a decorator in an interpreted language which is translated based on the interpreter; or
a mechanism which specifies a special characteristic of the region of code based on the compiler or the interpreter.

12. The computer system of claim 9, wherein the instructions are further to:
apply the power profile to the translated annotated region of code,
wherein the power profile comprises at least one of:
a power-save mode in which one or more power-saving operations are performed at or before runtime execution of the translated annotated region of code;
a performance mode comprising a default mode in which performance-optimizing operations are performed at or before runtime execution of the translated annotated region of code; or
a balanced power mode in which a mix of power-saving operations and performance-optimizing operations are performed at or before runtime execution of the translated annotated region of code; and
apply the power profile as part of code generation by the compiler or the interpreter.

13. The computer system of claim 9, wherein the instructions are further to:
perform the power-saving operation before execution, which comprises at least one of:
inserting a stall cycle or a pause instruction;
reducing floating point precision;
reducing vectorization used by one or more microprocessors; or
reducing parallelism in a distribution or span of resources; and
perform the power-saving operation at execution, which comprises:
determining that an architecture associated with the runtime execution supports cores associated with a variation in clock speeds; and
scheduling the runtime execution on a first core instead of a second core,
wherein the first core is associated with a first clock speed and the second core is associated with a second clock speed, and
wherein the first clock speed is slower than the second clock speed.

14. The computer system of claim 9,
wherein the region of code in the program is annotated by a developer of the program,
wherein the indicated power profile comprises an application programming interface (API) call, and
wherein the API call takes as input the power profile as a new power profile and associated parameters, switches a current power profile from a previous power profile to the new power profile, and returns the previous power profile.

15. A non-transitory computer-readable medium storing instructions which when executed by a processing resource comprise instructions to:
identify, in a program, a region of code annotated with a power profile;
translate the program based on a compiler or an interpreter;
insert, in the translated program based on the annotated region of code, a call to a power-control function corresponding to the power profile, wherein the power profile comprises a power-saving operation to be performed at or before runtime execution of the translated annotated region of code; and
perform the power-saving operation at or before runtime execution of the translated program based on the inserted call to the power-control function.

16. The non-transitory computer-readable medium of claim 15,
wherein the program in which the region of code is annotated is based on a compiled language or an interpreted language,
wherein the translated program based on the compiler or the interpreter comprises, respectively, compiled binary code or an intermediate representation of interpreted code, both of which include the inserted call to the power-control function.

17. The non-transitory computer-readable medium of claim 15, wherein the instructions are further to:
apply the power profile to the translated annotated region of code,
wherein the power profile comprises at least one of:
a power-save mode in which one or more power-saving operations are performed at or before runtime execution of the translated annotated region of code;
a performance mode comprising a default mode in which performance-optimizing operations are performed at or before runtime execution of the translated annotated region of code; or
a balanced power mode in which a mix of power-saving operations and performance-optimizing operations are performed at or before runtime execution of the translated annotated region of code.

18. The non-transitory computer-readable medium of claim 15, wherein the instructions are further to:
perform the power-saving operation before execution, which comprises at least one of:
inserting a stall cycle or a pause instruction;
reducing floating point precision;
reducing vectorization used by one or more microprocessors; or
reducing parallelism in a distribution or span of resources.

19. The non-transitory computer-readable medium of claim 15, wherein the instructions are further to:
perform the power-saving operation at execution, which comprises:
determining that an architecture associated with the runtime execution supports cores associated with a variation in clock speeds; and
scheduling the runtime execution on a first core instead of a second core,
wherein the first core is associated with a first clock speed and the second core is associated with a second clock speed, and
wherein the first clock speed is slower than the second clock speed.

20. The non-transitory computer-readable medium of claim 15,
wherein the region of code in the program is annotated by a developer of the program and indicated by at least one of:
a pragma or an attribute in a compiled language which is translated based on the compiler;
a decorator in an interpreted language which is translated based on the interpreter; or
a mechanism which specifies a special characteristic of the region of code based on the compiler or the interpreter,
wherein the indicated power profile comprises an application programming interface (API) call, and
wherein the API call takes as input the power profile as a new power profile and associated parameters, switches a current power profile from a previous power profile to the new power profile, and returns the previous power profile.
